(19) United States
(12) Patent Application Publication
(10) Pub. No.: US 2023/0112076 A1
(43) Pub. Date: Apr. 13, 2023

(54) LEARNING DEVICE, LEARNING METHOD, LEARNING PROGRAM, ESTIMATION DEVICE, ESTIMATION METHOD, AND ESTIMATION PROGRAM

(71) Applicant: NIPPON TELEGRAPH AND TELEPHONE CORPORATION, Tokyo (JP)

(72) Inventors: Shohei ENOMOTO, Musashino-shi, Tokyo (JP); Takeharu EDA, Musashino-shi, Tokyo (JP); Akira SAKAMOTO, Musashino-shi, Tokyo (JP); Kyoku SHI, Musashino-shi, Tokyo (JP); Yoshihiro IKEDA, Musashino-shi, Tokyo (JP)

(73) Assignee: NIPPON TELEGRAPH AND TELEPHONE CORPORATION, Tokyo (JP)

(21) Appl. No.: 17/801,272

(22) PCT Filed: Mar. 6, 2020
(86) PCT No.: PCT/JP2020/009878

§ 371 Date: Aug. 22, 2022

(51) Int. Cl. G06N 20/20; G06F 18/21

(52) U.S. Cl. CPC G06N 20/20; G06F 18/217

(57) ABSTRACT

An estimation unit inputs learning data to a lightweight model for outputting an estimation result in accordance with data input and acquires a first estimation result. Further, the updating unit updates a parameter of the lightweight model so that a model cascade including the lightweight model and a high-accuracy model is optimized in accordance with the first estimation result and a second estimation result obtained by inputting the learning data to the high-accuracy model, which is a model for outputting an estimation result in accordance with input data and has a lower processing speed than the first model or a higher estimation accuracy than the lightweight model.

### TECHNICAL FIELD

The present disclosure relates to a learning apparatus, a learning method, a learning program, an estimation apparatus, an estimation method, and an estimation program.

### BACKGROUND ART

Real-time applications, such as video surveillance, voice assistants, and automated driving using a deep neural network (DNN) have appeared. For such real-time applications, processing a large number of queries in real time with limited resources while maintaining the accuracy of the DNN is awaited. Thus, a technology of a model cascade capable of speeding up inference processing with decrease in accuracy by using a lightweight model with a high speed and low accuracy and a high-accuracy model with a low speed and high accuracy has been proposed.

The model cascade uses a plurality of models including a lightweight model and a high-accuracy model. When inference using the model cascade is performed, estimation is performed with the lightweight model first, and when its estimation result is reliable, the result is adopted to terminate processing. On the other hand, when the estimation result of the lightweight model is not reliable, inference is then performed with the high-accuracy model and its estimation result is adopted. For example, an I Don't Know (IDK) cascade (see, for example, NPL 1) in which an IDK classifier is introduced to determine whether an estimation result of a lightweight model is reliable is known.

### CITATION LIST

### Non Patent Literature

NPL 1: Wang, Xin, et al. “Idk cascades: Fast deep learning by learning not to overthink.” arXiv preprint arXiv: 1706.00885 (2017).

### SUMMARY OF THE INVENTION

### Technical Problem

Unfortunately, an existing model cascade may generate a calculation cost and an overhead of calculation resources. For example, the technology of NPL 1 needs to provide an IDK classifier in addition to a lightweight classifier and a high-accuracy classifier. This increases one model, thus generating a calculation cost and an overhead of calculation resources.

### Means for Solving the Problem

To solve the above-described issue and achieve the object, a learning apparatus includes an estimation unit that inputs learning data to a first model for outputting an estimation result in accordance with data input and acquires a first estimation result, and an updating unit that updates a parameter of the first model so that a model cascade including the first model and a second model is optimized in accordance with correctness and certainty factor of the first estimation result and correctness of a second estimation result obtained by inputting the learning data to the second model, which is a model for outputting an estimation result in accordance with data input and has a lower processing speed than the first model or higher estimation accuracy than the first model.

### Effects of the Invention

The present disclosure allows for curbing a calculation cost of the model cascade and an overhead of calculation resources.

### BRIEF DESCRIPTION OF DRAWINGS

FIG. 1 is a diagram illustrating a model cascade.

FIG. 2 is a diagram illustrating a configuration example of a learning apparatus according to a first embodiment.

FIG. 3 is a diagram illustrating an example of a loss for each case.

FIG. 4 is a flowchart illustrating a flow of learning processing of a high-accuracy model.

FIG. 5 is a flowchart illustrating a flow of learning processing of a lightweight model.

FIG. 6 is a diagram illustrating a configuration example of an estimation system according to a second embodiment.

FIG. 7 is a flowchart illustrating a flow of estimation processing.

FIG. 8 is a diagram illustrating experimental results.

FIG. 9 is a diagram illustrating experimental results.

FIG. 10 is a diagram illustrating experimental results.

FIG. 11 is a diagram illustrating experimental results.

FIG. 12 is a diagram illustrating experimental results.

FIG. 13 is a diagram illustrating a configuration example of an estimation apparatus according to a third embodiment.

FIG. 14 is a diagram illustrating a model cascade including three or more models.

FIG. 15 is a flowchart illustrating a flow of learning processing of three or more models.

FIG. 16 is a flowchart illustrating a flow of estimation processing using three or more models.

FIG. 17 is a diagram illustrating an example of a computer that executes a learning program.

### DESCRIPTION OF EMBODIMENTS

Hereinafter, embodiments of a learning apparatus, a learning method, a learning program, an estimation apparatus, an estimation method, and an estimation program according to the present application will be described in detail with reference to the drawings. The present disclosure is not limited to embodiments that will be described below.

### First Embodiment

The learning apparatus according to a first embodiment learns a high-accuracy model and a lightweight model using input learning data. The learning apparatus outputs information on the learned high-accuracy model and information on the learned lightweight model. For example, the learning apparatus outputs parameters required to construct each model.

The high-accuracy model and the lightweight model are models that output estimation results based on input data. In the first embodiment, it is assumed that the high-accuracy model and the lightweight model are multi-class classification models in which an image is input and a probability of an object of each class appearing in the image is estimated. However, the high-accuracy model and the lightweight model are not limited to such a multi-class classification model, and may be any model to which machine learning can be applied.

It is assumed that the high-accuracy model has a lower processing speed and higher estimation accuracy than the lightweight model. The high-accuracy model may be known to simply have a lower processing speed than the lightweight model. In this case, the high-accuracy model is expected to have higher estimation accuracy than the lightweight model. Further, the high-accuracy model may be known to simply have higher estimation accuracy than the lightweight model. In this case, the lightweight model is expected to have a higher processing speed than the high-accuracy model.

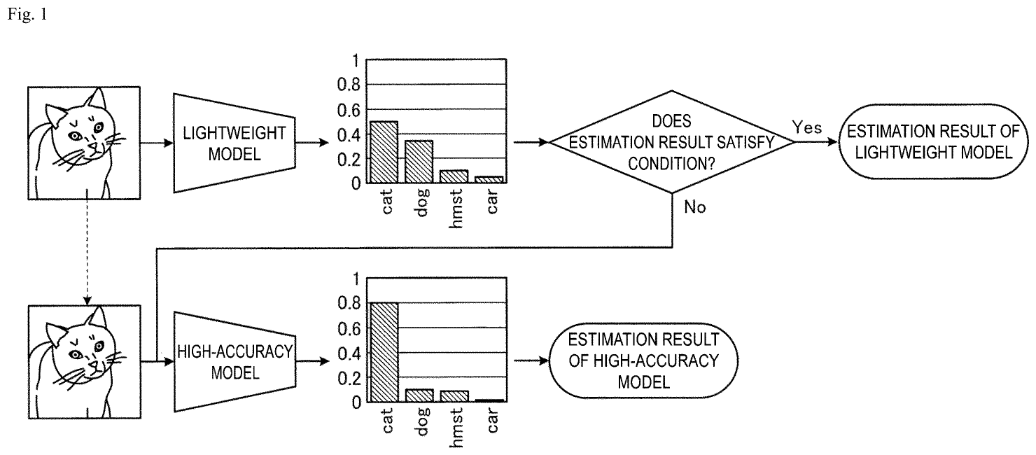

The high-accuracy model and the lightweight model constitute a model cascade. FIG. 1 is a diagram illustrating the model cascade. For description, two images are displayed in FIG. 1, but the images are the same images. As illustrated in FIG. 1, the lightweight model outputs a probability of each class for an object appearing in an input image. For example, the lightweight model outputs a probability that the object appearing in the image is a cat as about 0.5. Further, the lightweight model outputs a probability that the object appearing in the image is a dog as about 0.35.

Here, when an output of the lightweight model, that is, an estimation result, satisfies a condition, the estimation result is adopted. That is, the estimation result by the lightweight model is output as a final estimation result of the model cascade. On the other hand, when the estimation result by the lightweight model does not satisfy the condition, an estimation result obtained by inputting the same image to the high-accuracy model is output as the final estimation result of the model cascade. Here, the high-accuracy model outputs the probability of each class for the objects appearing in the input image, like the lightweight model. For example, the condition is that a maximum value of the probability output by the lightweight model exceeds a threshold value.

For example, the high-accuracy model is ResNet18 and operates on a server or the like. Further, for example, the lightweight model is MobileNet V2 and operates on an IoT device and various terminal apparatuses. The high-accuracy model and the lightweight model may operate on the same computer.

### Configuration of First Embodiment

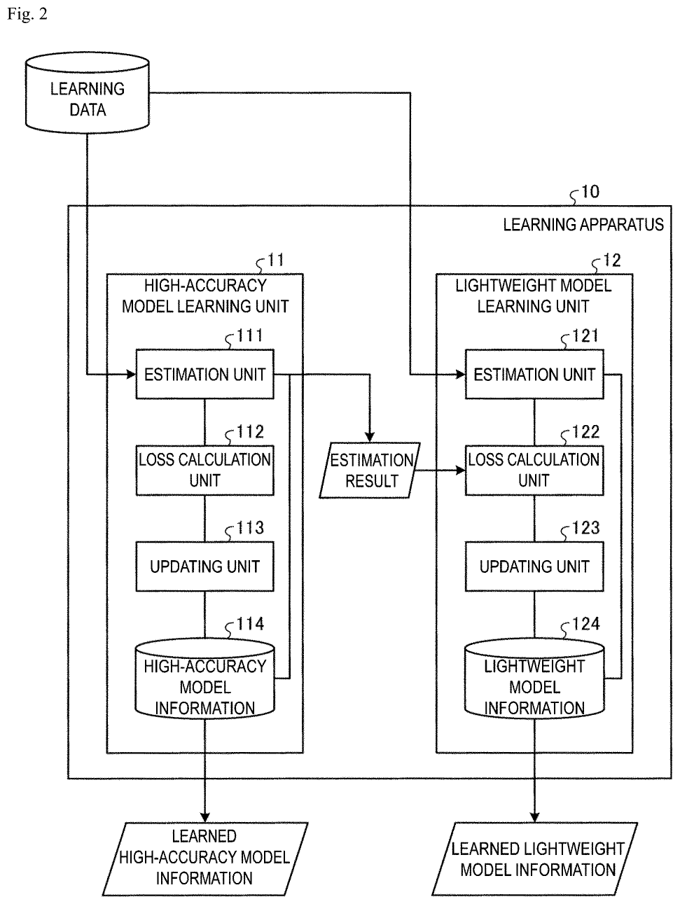

FIG. 2 is a diagram illustrating a configuration example of the learning apparatus according to the first embodiment. As illustrated in FIG. 2, the learning apparatus 10 receives an input of the learning data and outputs the learned high-accuracy model information and the learned lightweight model information. Further, the learning apparatus 10 includes a high-accuracy model learning unit 11 and a lightweight model learning unit 12.

The high-accuracy model learning unit 11 includes an estimation unit 111, a loss calculation unit 112, and an updating unit 113. Further, the high-accuracy model learning unit 11 stores high-accuracy model information 114. The high-accuracy model information 114 is information such as parameters for constructing the high-accuracy model. It is assumed that the learning data is data of which a label is known. For example, the learning data is a combination of an image and a label (a class of a correct answer).

The estimation unit 111 inputs the learning data to the high-accuracy model constructed based on the high-accuracy model information 114, and acquires an estimation result. The estimation unit 111 receives the input of the learning data and outputs the estimation result.

The loss calculation unit 112 calculates a loss based on the estimation result acquired by the estimation unit 111. The loss calculation unit 112 receives the input of the estimation result and the label, and outputs the loss. For example, the loss calculation unit 112 calculates the loss so that the loss is higher when the certainty factor of the label is lower in the estimation result acquired by the estimation unit 111. For example, the certainty factor is a degree of certainty that an estimation result is a correct answer. For example, the certainty factor may be a probability output by the above-described multi-class classification model. Specifically, the loss calculation unit 112 can calculate a softmax cross entropy, which will be described below, as the loss.

The updating unit 113 updates the parameters of the high-accuracy model so that the loss is optimized. For example, when the high-accuracy model is a neural network, the updating unit 113 updates the parameters of the high-accuracy model using an error back propagation method or the like. Specifically, the updating unit 113 updates the high-accuracy model information 114. The updating unit 113 receives the input of the loss calculated by the loss calculation unit 112, and outputs information on the updated model.

The lightweight model learning unit 12 includes an estimation unit 121, a loss calculation unit 122, and an updating unit 123. Further, the lightweight model learning unit 12 stores lightweight model information 124. The lightweight model information 124 is information such as parameters for constructing a lightweight model.

The estimation unit 121 inputs learning data to the lightweight model constructed based on the lightweight model information 124, and acquires an estimation result. The estimation unit 121 receives the input of the learning data and outputs an estimation result.

Here, the high-accuracy model learning unit 11 performs learning of the high-accuracy model based on the output of the high-accuracy model. On the other hand, the lightweight model learning unit 12 performs learning of the lightweight model based on the outputs of both the high-accuracy model and the lightweight model.

The loss calculation unit 122 calculates the loss based on the estimation result acquired by the estimation unit. The loss calculation unit 122 receives the estimation result by the high-accuracy model, the estimation result by the lightweight model, and the input of the label, and outputs the loss. The estimation result by the high-accuracy model may be an estimation result obtained by further inputting the learning data to the high-accuracy model after learning using the high-accuracy model learning unit 11 is performed. More specifically, the lightweight model learning unit 12 receives an input as to whether the estimation result by the high-accuracy model is a correct answer. For example, when a class of which a probability output by the high-accuracy model is highest matches the label, an estimation result thereof is a correct answer.

The loss calculation unit 122 calculates the loss for the purpose of maximization of profits in a case in which the model cascade has been configured, in addition to maximization of the estimation accuracy of the lightweight model alone. Here, it is assumed that the profits increase when the estimation accuracy is higher, and increase when the calculation cost decreases.

For example, the high-accuracy model is characterized in that the estimation accuracy is high, but the calculation cost is high. Further, further, for example, the lightweight model is characterized in that the estimation accuracy is low, but the calculation cost is low. Thus, the loss calculation unit 122 calculates a loss as in Equation (1). Here, w is a weight and is a preset parameter.

[Math. 1]

Loss=L_{classifier}+wL_{cascade} (1)

Here, L_{classifier} is a softmax entropy in the multi-class classification model. Further, L_{classifier} is an example of a first term that becomes larger when the certainty factor of the correct answer in the estimation result by the lightweight model is lower. L_{classifier} is expressed as in Equation (2). Here, N is the number of samples. Further, k is the number of classes. Further, y is a label indicating a class of a correct answer. Further, q is a probability output by the lightweight model. i is a number for identifying the sample. Further, j is a number for identifying the class. A label y_{i,j} becomes 1 when a jth class is a correct answer and becomes 0 when the jth class is an incorrect answer in an ith sample.

$$\begin{matrix}[ Math . 2 ] & \\ {L}_{classifier} = \frac{1}{N} {\sum }_{i = 1}^{N} \{ - {\sum }_{j = 1}^{K} {y}_{i , j} log {q}_{i , j} \} & ( 2 )\end{matrix}$$

Further, L_{cascade} is a term for maximizing profits in a case in which the model cascade has been configured. L_{cascade} indicates a loss in a case in which the estimation results of the high-accuracy model and the lightweight model are adopted based on the certainty factor of the lightweight model for each sample. Here, the loss includes a penalty for improper certainty factor and a cost of use of the high-accuracy model. Further, the loss is divided into four patterns according to a combination of whether the estimation result of the high-accuracy model is a correct answer and whether the estimation result by the lightweight model is a correct answer. Although details will be described below, the penalty increases when the estimation of the high-accuracy model is an incorrect answer and the certainty factor of the lightweight model is low. On the other hand, when the estimation of the lightweight model is a correct answer and the certainty factor of the lightweight model is high, the penalty becomes smaller. L_{cascade} is expressed by Equation (3).

$$\begin{matrix}[ Math . 3 ] & \\ {L}_{c a s c a d e} = \frac{1}{N} {\sum }_{i = 1}^{N} \{ {max}_{j} {q}_{i , j} {1}_{fast} + ( 1 - {max}_{j} {q}_{i , j} ) {1}_{a c c} + ( 1 - {max}_{j} {q}_{i , j} ) {COST}_{a c c} \} & ( 3 )\end{matrix}$$

1_{fast} is an indicator function that returns 0 when the estimation result by the lightweight model is a correct answer and 1 when the estimation result by the lightweight model is an incorrect answer. Further, lace is an indicator function that returns 0 when the estimation result of the high-accuracy model is a correct answer and 1 when the estimation result of the high-accuracy model is an incorrect answer. COST_{acc} is a cost required for estimation using the high-accuracy model and is a preset parameter.

maxᵢq_{i,j} is a maximum value of the probability output by the lightweight model, and is an example of the certainty factor. When the estimation result is a correct answer, it can be said that the estimation accuracy is higher when the certainty factor is higher. On the other hand, when the estimation result is an incorrect answer, it can be said that the estimation accuracy is lower when the certainty factor is higher.

maxᵢq_{i,j}1_{fast} in Equation (3) is an example of a second term that becomes larger when the certainty factor of the estimation result by the lightweight model is higher in a case in which the estimation result by the lightweight model is not correct. Further, (1−maxⱼq_{i,j})1_{acc} in Equation (3) is an example of a third term that becomes larger when the certainty factor of the estimation result by the lightweight model is lower in a case in which the estimation result by the high-accuracy model is not correct. Further, (1−maxⱼq_{i,j})COST_{acc} in Equation (3) is an example of a fourth term that becomes larger when the certainty factor of the estimation result by the lightweight model is lower. In this case, minimization of the loss by the updating unit 123 corresponds to optimization of the loss.

The updating unit 123 updates the parameters of the lightweight model so that the loss is optimized. That is, the updating unit 123 updates the parameters of the lightweight model so that the model cascade including the lightweight model and the high-accuracy model is optimized based on the estimation result by the lightweight model, and an estimation result obtained by inputting learning data to the high-accuracy model that is a model that outputs an estimation result based on input data and has a lower processing speed and higher estimation accuracy than the lightweight model. The updating unit 123 receives the input of the loss calculated by the loss calculation unit 122, and outputs the updated model information.

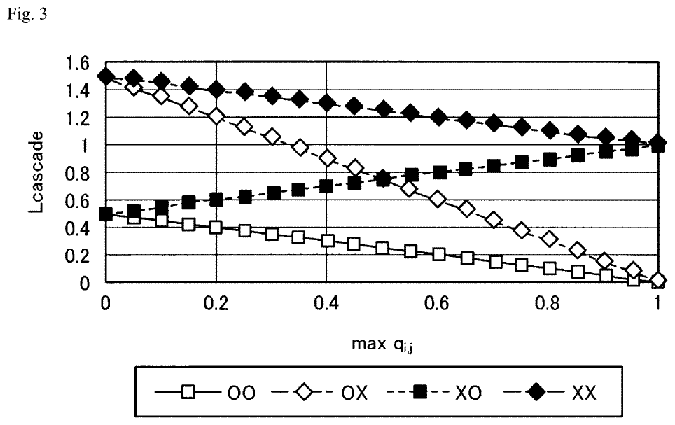

FIG. 3 is a diagram illustrating an example of a loss for each case. A vertical axis is a value of L_{cascade}. A horizontal axis is a value of maxⱼq_{i,j}. Further, COST_{acc}=0.5. maxⱼq_{i,j} is certainty factor of the estimation result by the lightweight model, and is simply called certainty factor here.

“□” in FIG. 3 is a value of L_{cascade} with respect to the certainty factor when the estimation results of both the lightweight model and the high-accuracy model are correct. In this case, the value of L_{cascade} becomes smaller when the certainty factor is higher. This is because, when the estimation result by the lightweight model is a correct answer, it becomes easy for the lightweight model to be adopted when the certainty factor is higher.

“⋄” in FIG. 3 is a value of L_{cascade} with respect to the certainty factor when the estimation result of the lightweight model is a correct answer and the estimation result of the high-accuracy model is an incorrect answer. In this case, when the certainty factor is higher, the value of L_{cascade} becomes smaller. Further, a maximum value of and a degree of decrease in L_{cascade} are larger than those of “□.” This is because, when the estimation result by the high-accuracy model is an incorrect answer and the estimation result by the lightweight model is a correct answer, it is easier for the lightweight model to be adopted when the certainty factor is higher.

“▪” in FIG. 3 is a value of L_{cascade} with respect to the certainty factor when the estimation result of the lightweight model is an incorrect answer and the estimation result of the high-accuracy model is a correct answer. In this case, when the certainty factor is higher, the value of L_{cascade} is larger. This is because, even in a case in which the estimation result of the lightweight model is an incorrect answer, it is more difficult for the estimation result to be adopted when the certainty factor is lower.

“♦” in FIG. 3 is a value of L_{cascade} with respect to the certainty factor in a case in which the estimation results of both the lightweight model and the high-accuracy model are incorrect. In this case, when the certainty factor is higher, a value of L_{cascade} becomes smaller. However, the value of L_{cascade} is larger than that of “□.” This is because a loss is always high due to the fact that the estimation results of both models are incorrect answers, and in such a situation, the lightweight model should be able to make an accurate estimation.

### Processing of First Embodiment

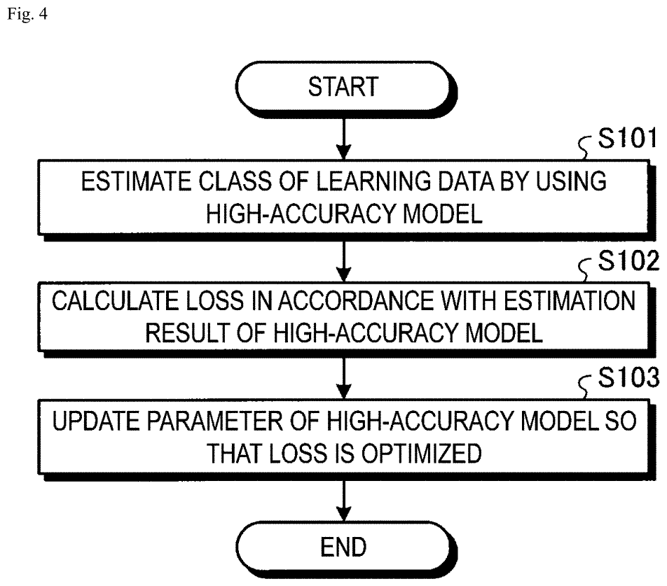

FIG. 4 is a flowchart illustrating a flow of learning processing of the high-accuracy model. As illustrated in FIG. 4, first, the estimation unit 111 estimates a class of learning data using the high-accuracy model (step S101).

Next, the loss calculation unit 112 calculates the loss based on the estimation result of the high-accuracy model (step S102). The updating unit 113 updates the parameters of the high-accuracy model so that the loss is optimized (step S103). The learning apparatus 10 may repeat processing from step S101 to step S103 until an end condition is satisfied. The end condition may be that processing is repeated a predetermined number of times, or that a parameter updating width has converged.

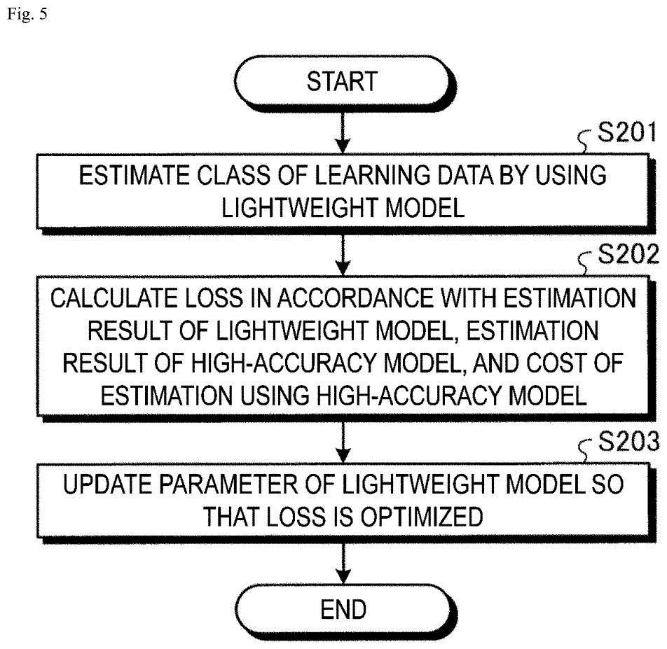

FIG. 5 is a flowchart illustrating a flow of learning processing of the lightweight model. As illustrated in FIG. 5, first, the estimation unit 121 estimates a class of learning data using a lightweight model (step S201).

Next, the loss calculation unit 122 calculates the loss based on the estimation result of the lightweight model, the estimation result of the high-accuracy model, and the estimation cost of the high-accuracy model (step S202). The updating unit 123 updates the parameters of the lightweight model so that the loss is optimized (step S203). The learning apparatus 10 may repeat processing from step S201 to step S203 until the end condition is satisfied.

### Effects of First Embodiment

As described above, the estimation unit 121 inputs the learning data to the lightweight model that outputs the estimation result based on the input data, and acquires a first estimation result. Further, the updating unit 123 updates the parameters of the lightweight model so that the model cascade including the lightweight model and the high-accuracy model is optimized based on the first estimation result, and the second estimation result obtained by inputting learning data to the high-accuracy model that is a model that outputs an estimation result based on input data and has a lower processing speed and a higher estimation accuracy than the lightweight model. Thus, in the first embodiment, in the model cascade including the lightweight model and the high-accuracy model, the lightweight model performs estimation suitable for the model cascade without providing a model such as an IDK classifier, thereby improving performance of the model cascade. As a result, according to the first embodiment, it is possible to not only improve the accuracy of the model cascade, but also curb a calculation cost and an overhead of calculation resources. Further, in the first embodiment, because a loss function is changed, it is not necessary to change a model architecture, and there is no limitation on a model to be applied or an optimization method.

The updating unit 123 updates the parameters of the lightweight model so that the loss calculated based on a loss function including a first term that becomes larger when certainty factor of the correct answer in the first estimation result is lower, a second term that becomes larger when the certainty factor of the first estimation result is higher in a case in which the first estimation result is an incorrect answer, a third term that becomes larger when the certainty factor of the first estimation result is lower in a case in which the second estimation result is an incorrect answer, and a fourth term that becomes larger when the certainty factor of the first estimation result is lower is minimized. As a result, in the first embodiment, in the model cascade including the lightweight model and the high-accuracy model, it is possible to improve the estimation accuracy of the model cascade in consideration of a cost when the estimation result of the high-accuracy model is adopted.

### Second Embodiment

### Configuration of Second Embodiment

In a second embodiment, an estimation system that performs estimation using a learned high-accuracy model and a lightweight model will be described. According to the estimation system of the second embodiment, it is possible to perform estimation using the model cascade with high accuracy without providing an IDK classifier or the like. Further, in the following description of the embodiment, units having the same functions as those of the described embodiments are denoted by the same reference signs, and description thereof will be appropriately omitted.

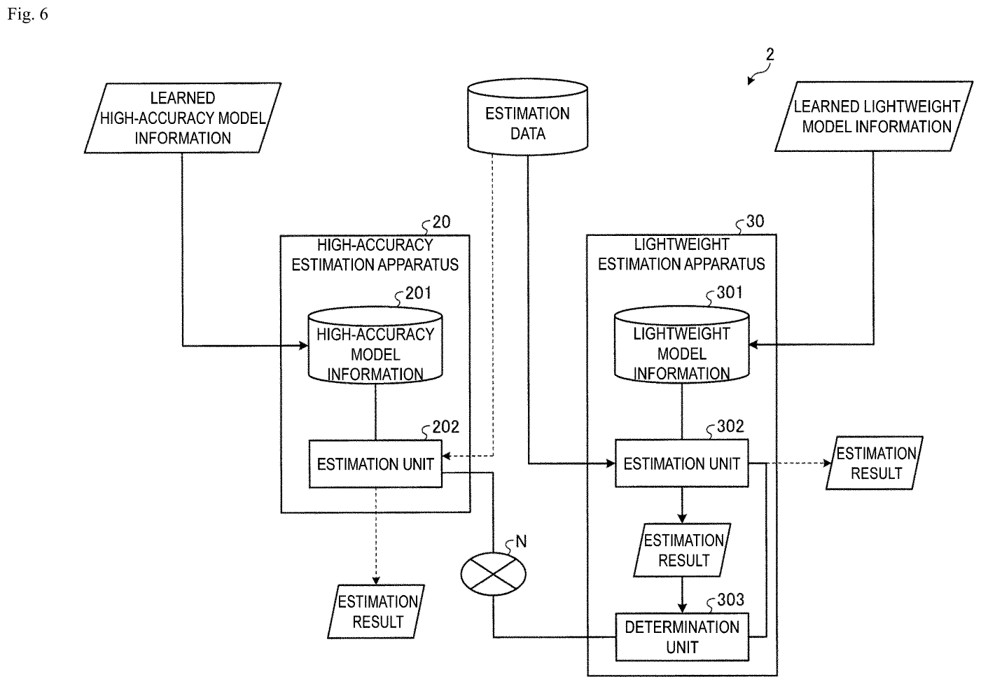

As illustrated in FIG. 6, the estimation system 2 includes a high-accuracy estimation apparatus 20 and a lightweight estimation apparatus 30. Further, the high-accuracy estimation apparatus 20 and the lightweight estimation apparatus 30 are connected via a network N. The network N is, for example, the Internet. In this case, the high-accuracy estimation apparatus 20 may be a server provided in a cloud environment. Further, the lightweight estimation apparatus 30 may be an IoT device and various terminal apparatuses.

As illustrated in FIG. 6, the high-accuracy estimation apparatus 20 stores high-accuracy model information 201. The high-accuracy model information 201 is information such as parameters of the learned high-accuracy model. Further, the high-accuracy estimation apparatus 20 includes an estimation unit 202.

The estimation unit 202 inputs estimation data to the high-accuracy model constructed based on the high-accuracy model information 201, and acquires an estimation result. The estimation unit 202 receives an input of the estimation data and outputs the estimation result. It is assumed that the estimation data is data of which a label is unknown. For example, the estimation data is an image.

Here, the high-accuracy estimation apparatus 20 and the lightweight estimation apparatus 30 constitute a model cascade. Thus, the estimation unit 202 does not always perform estimation for the estimation data. When a determination is made that the estimation result by the lightweight model is not adopted, the estimation unit 202 performs estimation using the high-accuracy model.

The lightweight estimation apparatus 30 stores lightweight model information 301. The lightweight model information 301 is information such as parameters of the learned lightweight model. Further, the lightweight estimation apparatus 30 includes an estimation unit 302 and a determination unit 303.

The estimation unit 302 inputs the estimation data to the lightweight model having set parameters learned in advance so that the model cascade including the lightweight model and the high-accuracy model is optimized based on the estimation result obtained by inputting the learning data to the lightweight model that outputs an estimation result based on the input data and the estimation result obtained by inputting learning data to the high-accuracy model that is a model that outputs an estimation result based on input data and has a higher estimation accuracy than the lightweight model, and acquires an estimation result. The estimation unit 302 receives the input of the estimation data and outputs the estimation result.

Further, the determination unit 303 determines whether the estimation result by the lightweight model satisfies a predetermined condition regarding the estimation accuracy. For example, the determination unit 303 determines that the estimation result by the lightweight model satisfies the condition when the certainty factor is equal to or higher than a threshold value. In this case, the estimation system 2 adopts the estimation result by the lightweight model.

Further, when the determination unit 303 determines that the estimation result by the lightweight model does not satisfy the condition, the estimation unit 202 of the high-accuracy estimation apparatus 20 inputs the estimation data to the high-accuracy model and acquires the estimation result. In this case, the estimation system 2 adopts the estimation result of the high-accuracy model.

### Processing of Second Embodiment

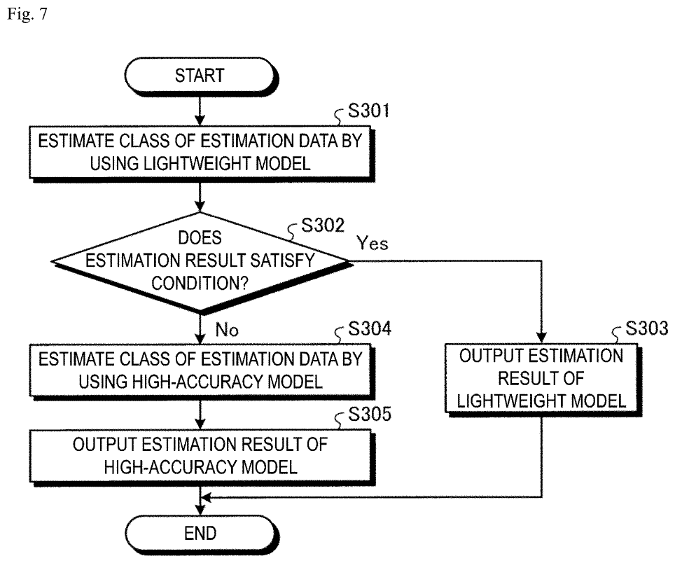

FIG. 7 is a flowchart illustrating a flow of estimation processing. As illustrated in FIG. 7, first, the estimation unit 302 estimates the class of the estimation data using the lightweight model (step S301).

Here, the determination unit 303 determines whether the estimation result satisfies the condition (step S302). When the estimation result satisfies the condition (step S302: Yes), the estimation system 2 outputs the estimation result by the lightweight model (step S303).

On the other hand, when the estimation result does not satisfy the condition (step S302, No), the estimation unit 202 estimates a class of estimation data using the high-accuracy model (step S304). The estimation system 2 outputs the estimation result of the high-accuracy model (step S305).

### Effects of Second Embodiment

As described above, the estimation unit 302 inputs the estimation data to the lightweight model having set parameters learned in advance so that the model cascade including the lightweight model and the high-accuracy model is optimized based on the estimation result obtained by inputting the learning data to the lightweight model that outputs an estimation result based on the input data and the estimation result obtained by inputting learning data to the high-accuracy model that is a model that outputs an estimation result based on input data and has a higher estimation accuracy than the lightweight model, and acquires an estimation result. Further, the determination unit 303 determines whether the estimation result by the lightweight model satisfies the predetermined condition regarding the estimation accuracy. Thus, in the second embodiment, in the model cascade including the lightweight model and the high-accuracy model, it is possible to perform high-accuracy estimation while curbing the occurrence of an overhead.

When the determination unit 303 determines that the estimation result by the lightweight model does not satisfy the condition, the estimation unit 202 inputs the estimation data to the high-accuracy model and acquires the estimation result. Thus, according to the second embodiment, it is possible to obtain a high-accuracy estimation result even when the estimation result by the lightweight model cannot be adopted.

Here, the estimation system 2 according to the second embodiment can be expressed as follows. That is, the estimation system 2 includes a high-accuracy estimation apparatus 20 and a lightweight estimation apparatus 30. The lightweight estimation apparatus 30 includes the estimation unit 302 that inputs the estimation data to the lightweight model having set parameters learned in advance so that the model cascade including the lightweight model and the high-accuracy model is optimized based on the estimation result obtained by inputting the learning data to the lightweight model that outputs an estimation result based on the input data and the estimation result obtained by inputting learning data to the high-accuracy model that is a model that outputs an estimation result based on input data and has a lower processing speed than the lightweight model or a higher estimation accuracy than the lightweight model, and acquires the first estimation result, and the determination unit 303 that determines whether the first estimation result satisfies a predetermined condition regarding estimation accuracy. The high-accuracy estimation apparatus 20 includes the estimation unit 202 that inputs the estimation data to the high-accuracy model and acquires a second estimation result when the determination unit 303 determines that the first estimation result does not satisfy the condition. Further, the high-accuracy estimation apparatus 20 may acquire the estimation data from the lightweight estimation apparatus 30.

The estimation unit 202 performs estimation according to a result of estimation of the lightweight estimation apparatus 30. That is, the estimation unit 202 inputs the estimation data to the high-accuracy model according to the first estimation result acquired by the lightweight estimation apparatus 30 inputting the estimation data to the lightweight model having set parameters learned in advance so that the model cascade including the lightweight model and the high-accuracy model is optimized based on the estimation result obtained by inputting the learning data to the lightweight model that outputs an estimation result based on the input data and the estimation result obtained by inputting learning data to the high-accuracy model that is a model that outputs an estimation result based on input data and has a lower processing speed or a higher estimation accuracy than the lightweight model, and acquires a second estimation result.

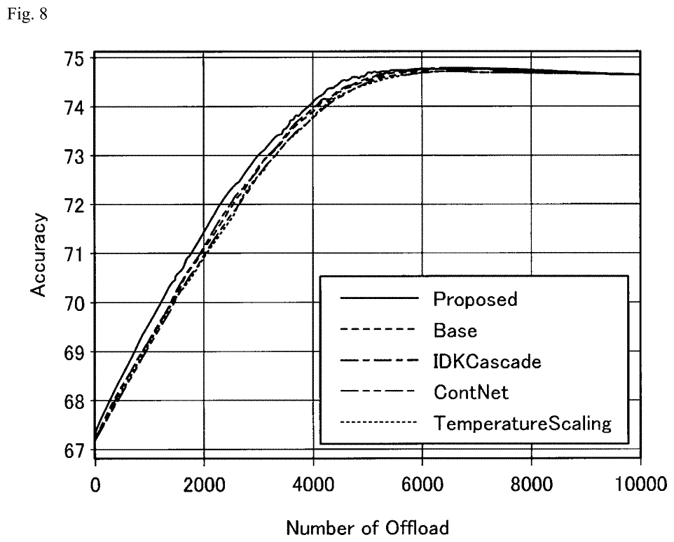

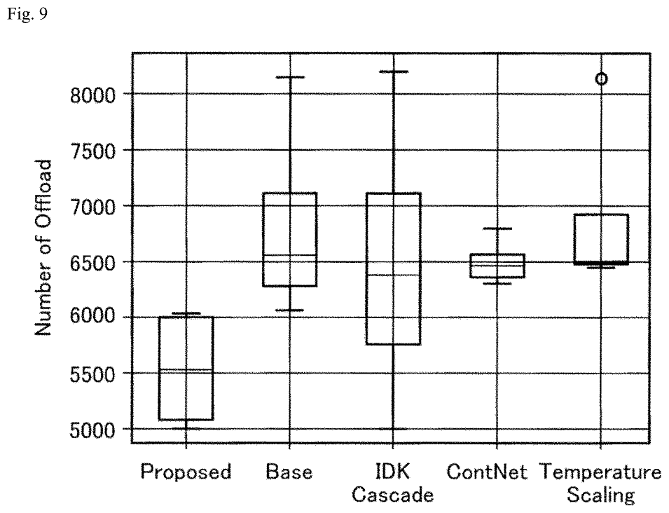

Experiment Here, an experiment performed to confirm the effects of the embodiment and results thereof will be described. FIGS. 8 to 9 are diagrams illustrating experimental results. In the experiment, it is assumed that the determination unit 303 in the second embodiment determines whether the certainty factor level exceeds a threshold value. Respective settings in the experiment are as follows.

### Data set: CIFAR100

train: 45000, validation: 5000, test: 10000
Lightweight model: MobileNet V2
High-accuracy model: ResNet18
Model learning method

### Momentum SGD

lr=0.01, momentum=0.9, weight decay=5e-4
lr is 0.2 times with 60, 120, 160 epochs
batch size: 128
Comparison scheme (five experiments each)
Base: a maximum value of class probability is used
IDK Cascades (see NPL 1)
ConfNet (see Reference 1)
Temperature Scaling (see Reference 2)

### Second Embodiment

Accuracy: Accuracy when inference is performed in a model cascade configuration
Number of offloads: Number of inferences made with a high-accuracy model
(Reference 1) Wan, Sheng, et al. “Confnet: Predict with Confidence.” 2018 IEEE International Conference on Acoustics, Speech and Signal Processing (ICASSP). IEEE, 2018.
(Reference 2) Guo, Chuan, et al. “On calibration of model neural networks.” Proceedings of the 34th International Conference on Machine Learning-Volume 70. JMLR. org, 2017.

Using the test data, estimation is actually performed using each scheme including the second embodiment, and a relationship between the number of offloads and the accuracy when a threshold value is changed from 0 to 1 in 0.01 increments is illustrated in FIG. 8. As illustrated in FIG. 8, a scheme of the embodiment (proposed) shows higher accuracy than other schemes even when the number of offloads is reduced.

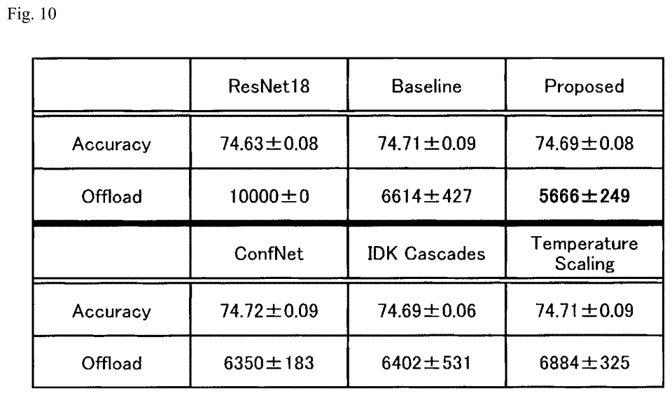

Further, a relationship between the number of offloads and the accuracy when a threshold value in which the highest accuracy is obtained in the validation data is adopted and estimation of the test data is performed is illustrated in FIGS. 9 and 10. From this, it can be seen that the number of offloads is most reduced while maintaining the accuracy of the high-accuracy model according to the second embodiment.

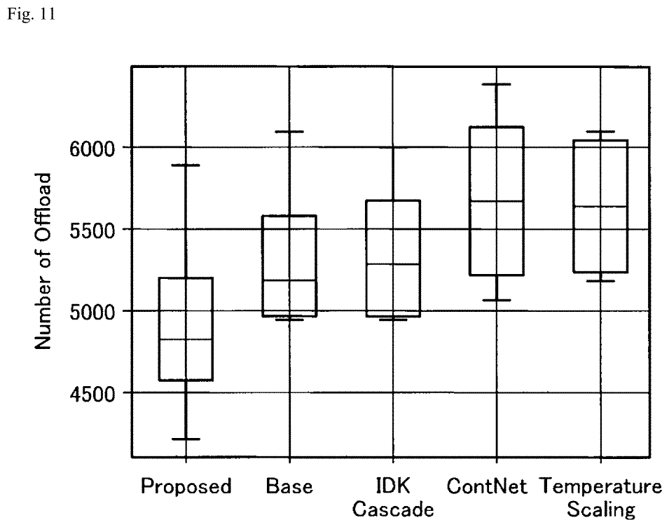

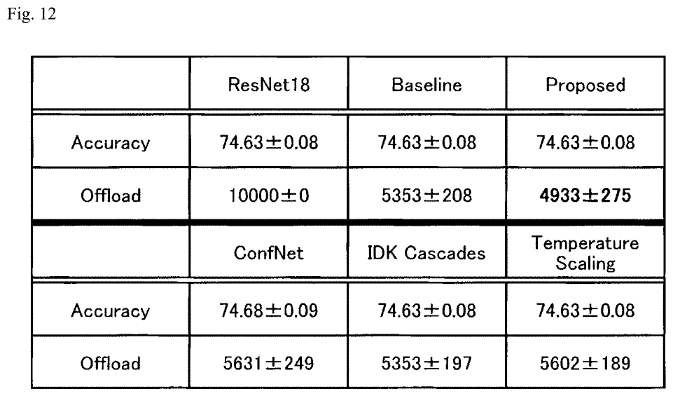

Further, a relationship between the number of offloads and the accuracy when the number of offloads is most reduced while maintaining the accuracy of the high-accuracy model in the test data is illustrated in FIGS. 11 and 12. From this, it can be seen that the number of offloads is most reduced according to the second embodiment.

### Third Embodiment

In the second embodiment, an example in which an apparatus that performs estimating using the lightweight model and an apparatus that performs estimation using the high-accuracy model are separate has been described. On the other hand, the estimation of the lightweight model and the estimation of the high-accuracy model may be performed by the same apparatus.

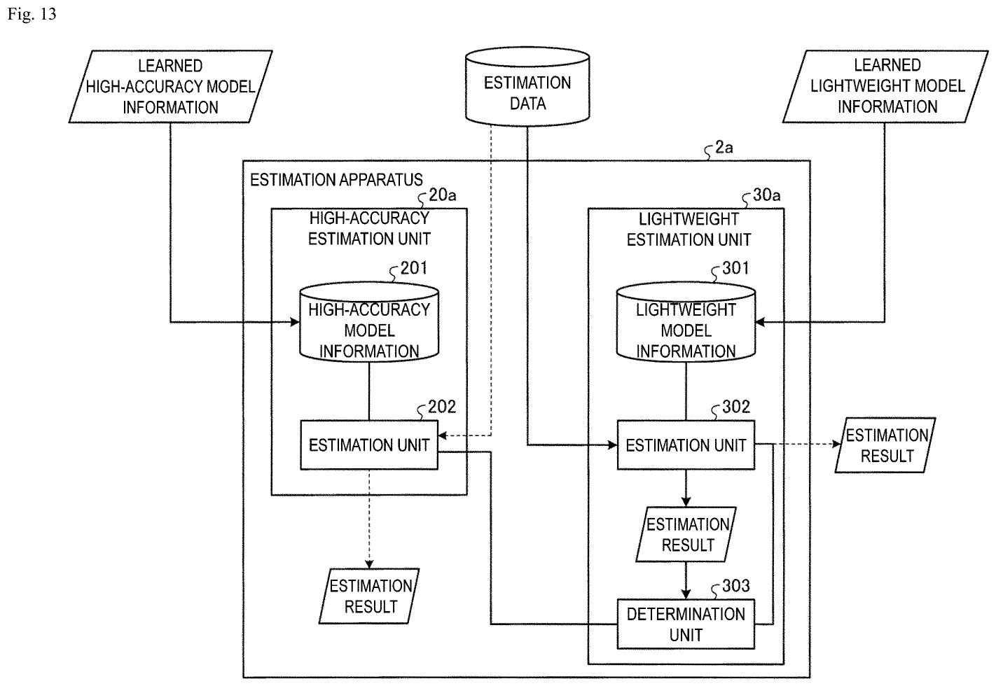

FIG. 13 is a diagram illustrating a configuration example of an estimation apparatus according to a third embodiment. An estimation apparatus 2a has the same function as the estimation system 2 of the second embodiment. Further, a high-accuracy estimation unit 20a has the same function as the high-accuracy estimation apparatus 20 of the second embodiment. Further, the lightweight estimation unit 30a has the same function as the lightweight estimation apparatus 30 of the second embodiment. Unlike the second embodiment, because the estimation unit 202 and the determination unit 303 are in the same apparatus, data exchange via a network does not occur in estimation processing.

### Fourth Embodiment

The embodiments in a case in which there are two models including the lightweight model and the high-accuracy model have been described. On the other hand, the embodiments described so far can be extended to a case in which there are three or more models.

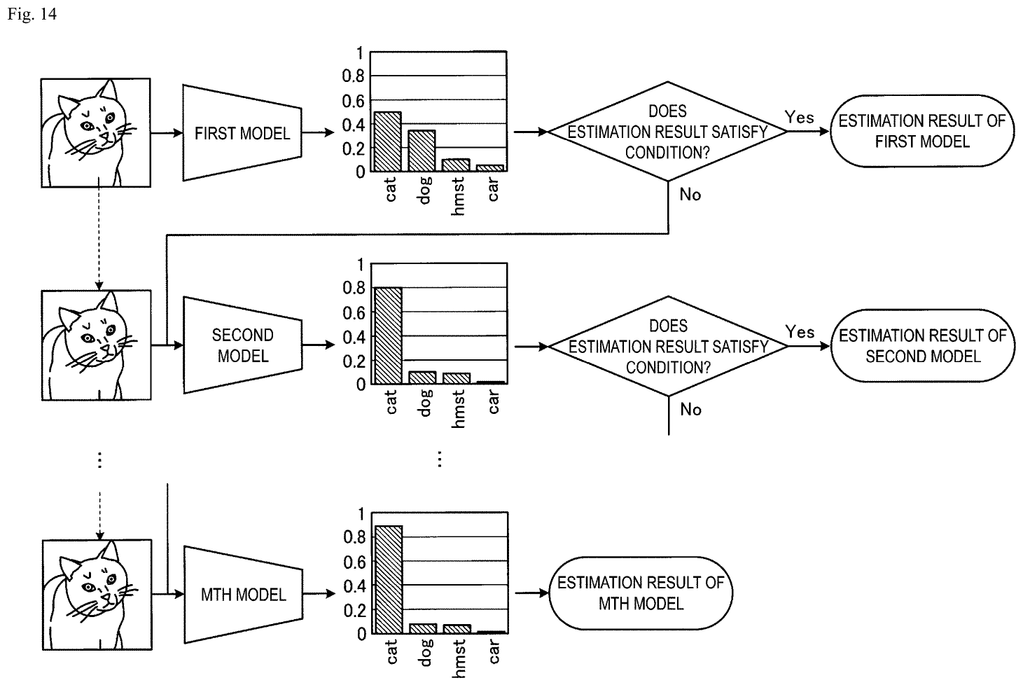

FIG. 14 is a diagram illustrating a model cascade including three or more models. Here, it is assumed that there are M (M>3) models. It is assumed that a (m+1)th model (M−1≥m≥1) has a lower processing speed than the mth model or a higher estimation accuracy than the mth model. That is, a relationship between a (m+1)th model and an mth model is the same as a relationship between the high-accuracy model and the lightweight model. Further, an Mth model is the highest-accurate model, and a first model can be said to be the lightest model.

The fourth embodiment allows for estimation processing of three or more models by using the estimation system 2 described in the second embodiment. First, the estimation system 2 replaces the high-accuracy model information 201 with information on a second model and the lightweight model information 301 with information on the first model. The estimation system 2 executes the same estimation processing as in the second embodiment.

Thereafter, when an estimation result of the first model does not satisfy the condition and an estimation result of the second model does not satisfy the condition, the estimation system 2 replaces the high-accuracy model information 201 with information on a third model, replaces the lightweight model information 301 with the information on the second model, and further executes the estimation processing. The estimation system 2 repeats this processing until an estimation result satisfying the condition is obtained or estimation processing of the Mth model ends. The same processing can be achieved only with the lightweight estimation apparatus 30 by replacing the lightweight model information 301.

Further, in the fourth embodiment, it is possible to use the learning apparatus 10 described in the first embodiment to realize the learning processing of three or more models. The learning apparatus 10 extracts two models having consecutive numbers from M models, and executes the learning processing using information on these models. First, the learning apparatus 10 replaces the high-accuracy model information 114 with information on the Mth model, and replaces the lightweight model information 124 with information on the (M−1)th model. The learning apparatus 10 executes the same learning processing as in the first embodiment. As a generalization, the learning apparatus 10 replaces the high-accuracy model information 114 with information on a mth model, replaces the lightweight model information 124 with information on a (m−1)th model, and then executes the same learning processing as in the first embodiment.

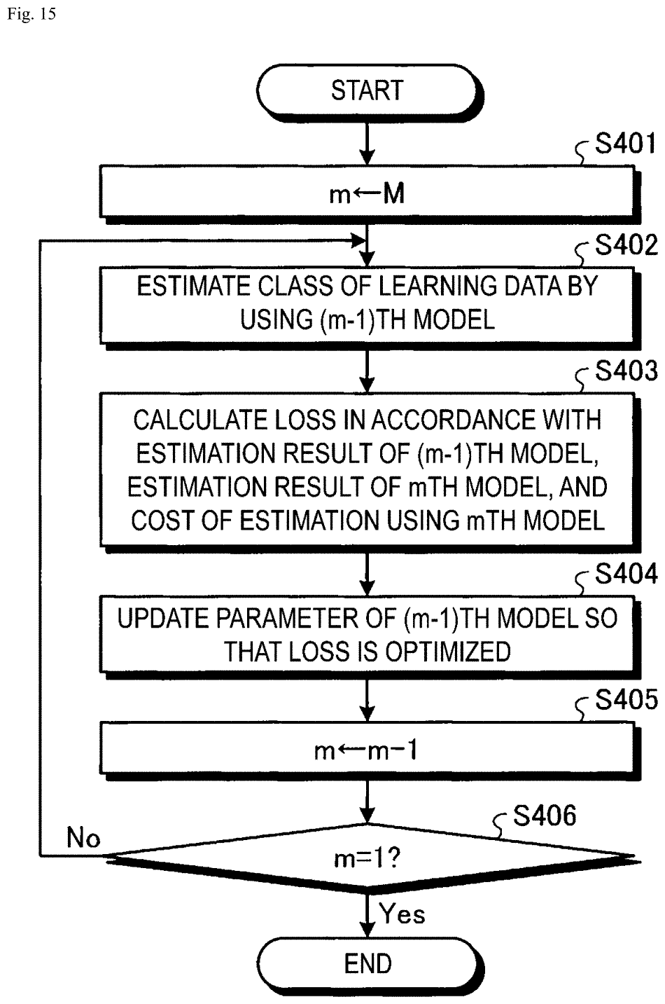

FIG. 15 is a flowchart illustrating a flow of learning processing of three or more models. Here, it is assumed that the learning apparatus 10 of the first embodiment performs the learning processing. As illustrated in FIG. 15, first, the learning apparatus 10 sets M as an initial value of m (step S401). The estimation unit 121 estimates a class of learning data using the (m−1)th model (step S402).

Next, the loss calculation unit 122 calculates the loss based on an estimation result of the (m−1)th model, an estimation result of the mth model, and an estimation cost of the mth model (step S403). The updating unit 123 updates parameters of the (m−1)th model so that the loss is optimized (step S404).

Here, the learning apparatus 10 reduces m by 1 (step S405). When m reaches 1 (step S406: Yes), the learning apparatus 10 ends the processing. On the other hand, when m has not reached 1 (step S406: No), the learning apparatus 10 returns to step S402 and repeats the processing.

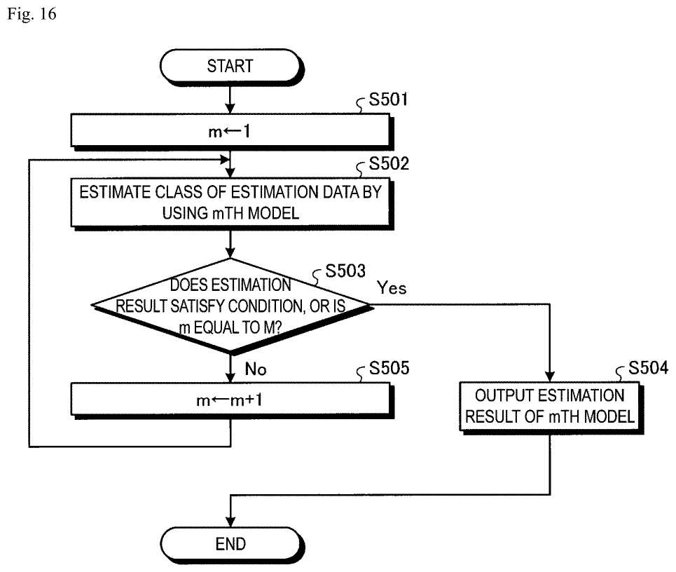

FIG. 16 is a flowchart illustrating a flow of estimation processing using three or more models. Here, it is assumed that the lightweight estimation apparatus 30 of the second embodiment performs the estimation processing. As illustrated in FIG. 16, first, the lightweight estimation apparatus 30 sets 1 as the initial value of m (step S501). The estimation unit 302 estimates the class of the estimation data using the mth model (step S502).

Here, the determination unit 303 determines whether the estimation result satisfies the condition and whether m reaches M (step S503). When the estimation result satisfies the condition or m reaches M (step S503: Yes), the lightweight estimation apparatus 30 outputs an estimation result of the mth model (step S504).

On the other hand, when the estimation result does not satisfy the condition and m does not reach M (step S503: No), the estimation apparatus 30 increments m by 1 (step S505), returns to step S502, and repeats the processing.

For example, in the related art, as the number of models increases, the number of IDK classifiers increases and a calculation cost and an overhead of calculation resources increase. On the other hand, according to the fourth embodiment, even when the number of models constituting the model cascade is increased to three or more, such a problem of an increase in such overhead does not occur.

System Configuration, or Like

Further, respective components of each of the illustrated apparatuses are functionally conceptual ones, and are not necessarily physically configured as illustrated in the figures. That is, a specific form of distribution and integration of the respective apparatuses is not limited to the form illustrated in the drawings, and all or some of the apparatuses can be distributed or integrated functionally or physically in any units according to various loads, and use situations. Further, all or some of processing functions to be performed in each of the apparatuses can be realized by a CPU and a program analyzed and executed by the CPU, or can be realized as hardware using a wired logic.

Further, all or some of the processing described as being performed automatically among the processing described in the present embodiment can be performed manually, and alternatively, all or some of the processing described as being performed manually can be performed automatically using a known method. In addition, information including the processing procedures, control procedures, specific names, and various types of data or parameters illustrated in the above literature or drawings can be arbitrarily changed unless otherwise described.

Program

In an embodiment, the learning apparatus 10 and the lightweight estimation apparatus 30 can be implemented by installing a program for executing the above learning processing or estimation processing as package software or online software in a desired computer. For example, the information processing apparatus is caused to execute the above program, making it possible to cause the information processing apparatus to function as the learning apparatus 10 or the lightweight estimation apparatus 30. Here, the information processing apparatus includes a desktop or laptop personal computer. Further, a mobile communication terminal such as a smart phone, a mobile phone, or a personal handyphone system (PHS), or a slate terminal such as a personal digital assistant (PDA), for example, is included in a category of the information processing apparatus.

Further, the learning apparatus 10 and the lightweight estimation apparatus 30 can be implemented as a server apparatus in which a terminal apparatus used by a user is used as a client and a service regarding the learning processing or the estimation processing is provided to the client. For example, the server apparatus is implemented as a server apparatus that provides a service in which learning data is an input and information on a learned model is an output. In this case, the server apparatus may be implemented as a Web server, or may be implemented as a cloud that provides services regarding the above processing through outsourcing.

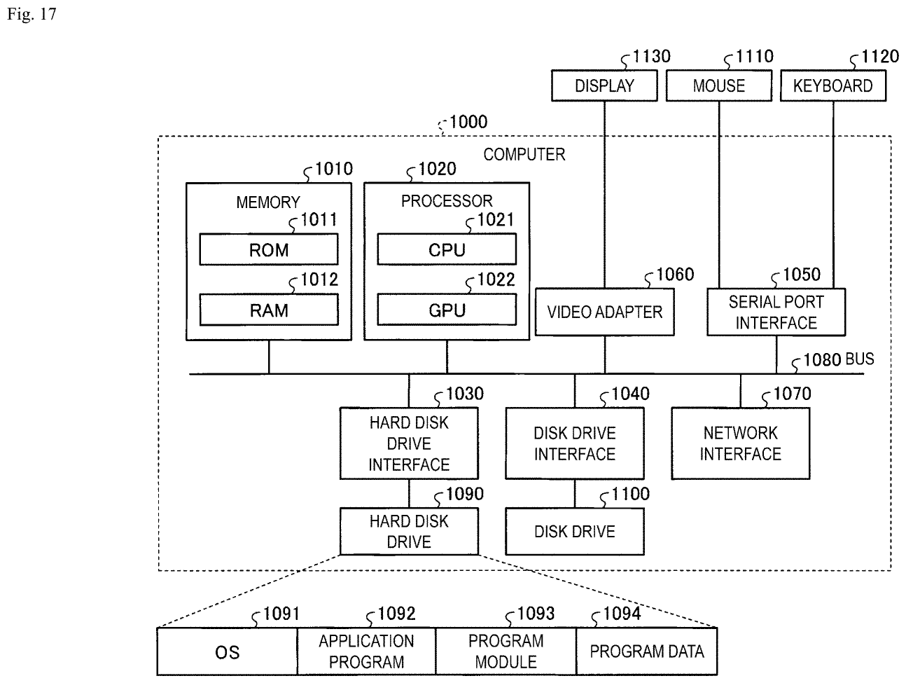

FIG. 17 is a diagram illustrating an example of a computer that executes a learning program. The estimation program may also be executed by a similar computer. A computer 1000 includes, for example, a memory 1010 and a processor 1020. The computer 1000 also includes a hard disk drive interface 1030, a disc drive interface 1040, a serial port interface 1050, a video adapter 1060, and a network interface 1070. Each of these units is connected by a bus 1080.

The memory 1010 includes a read only memory (ROM) 1011 and a RAM 1012. The ROM 1011 stores, for example, a boot program such as a basic input output system (BIOS). The processor 1020 includes a CPU 1021 and a graphics processing unit (GPU) 1022. The hard disk drive interface 1030 is connected to a hard disk drive 1090. The disc drive interface 1040 is connected to a disc drive 1100. For example, a removable storage medium such as a magnetic disk or an optical disc is inserted into the disc drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and a program data 1094. That is, a program that defines each processing of the learning apparatus 10 is implemented as the program module 1093 in which a code that can be executed by a computer is described. The program module 1093 is stored in, for example, the hard disk drive 1090. For example, the program module 1093 for executing the same processing as that of a functional configuration in the learning apparatus 10 is stored in the hard disk drive 1090. The hard disk drive 1090 may be replaced with an SSD.

Further, configuration data to be used in the processing of the embodiment described above is stored as the program data 1094 in, for example, the memory 1010 or the hard disk drive 1090. The CPU 1020 reads the program module 1093 or the program data 1094 stored in the memory 1010 or the hard disk drive 1090 into the RAM 1012 as necessary, and executes the processing of the embodiment described above.

The program module 1093 or the program data 1094 is not limited to being stored in the hard disk drive 1090 and, for example, may be stored in a detachable storage medium and read by the CPU 1020 via the disc drive 1100 or the like. Alternatively, the program module 1093 and the program data 1094 may be stored in another computer connected via a network (a local area network (LAN), a wide area network (WAN), or the like). The program module 1093 and the program data 1094 may be read by the CPU 1020 from another computer via the network interface 1070.

### REFERENCE SIGNS LIST

2 Estimation system
2a Estimation apparatus
10 Learning apparatus
11 High-accuracy model learning unit
12 Lightweight model learning unit
20 High-accuracy estimation apparatus
20a High-accuracy estimation unit
30 Lightweight estimation apparatus
30a Lightweight estimation unit
111, 121, 202, 302 Estimation unit
112, 122 Loss calculation unit
113, 123 Updating unit
114, 201 High-accuracy model information
124, 301 Lightweight model information
303 Determination unit

1. A learning apparatus comprising:
estimation circuity configured to input learning data to a first model for outputting an estimation result in accordance with data input and to acquire a first estimation result; and
updating circuitry configured to update a parameter of the first model so that a model cascade including the first model and a second model is optimized in accordance with the first estimation result and a second estimation result obtained by inputting the learning data to the second model, which is a model for outputting an estimation result in accordance with data input and has a lower processing speed than the first model or higher estimation accuracy than the first model.

2. The learning apparatus according to claim 1, wherein
the updating circuitry updates the parameter of the first model to optimize a loss calculated in accordance with a loss function including a first term that becomes larger as a certainty factor of a correct answer in the first estimation result is lower, a second term that becomes larger as the certainty factor of the first estimation result is higher when the first estimation result is an incorrect answer, a third term that becomes larger as the certainty factor of the first estimation result is lower when the second estimation result is an incorrect answer, and a fourth term that becomes larger as the certainty factor of the first estimation result is lower.

3. A learning method, comprising:
inputting learning data to a first model for outputting an estimation result in accordance with data input and acquiring a first estimation result; and
updating a parameter of the first model so that a model cascade including the first model and a second model is optimized in accordance with the first estimation result and a second estimation result obtained by inputting the learning data to the second model, the second model being a model for outputting an estimation result in accordance with data input and having a lower processing speed than the first model or higher estimation accuracy than the first model.

4. A non-transitory computer readable medium storing a learning program for causing a computer to operate as the learning apparatus according to claim 1.

5. An estimation apparatus comprising:
first estimation circuitry configured to input estimation data to a first model in which a parameter learned in advance is set so that a model cascade including the first model and a second model is optimized in accordance with an estimation result obtained by inputting learning data to the first model for outputting an estimation result in accordance with data input and an estimation result obtained by inputting the learning data to the second model and to acquire a first estimation result, the second model being a model for outputting an estimation result in accordance with data input and having a lower processing speed than the first model or higher estimation accuracy than the first model; and
determination circuitry configured to determine whether the first estimation result satisfies a predetermined condition regarding estimation accuracy.

6-7. (canceled)

8. A non-transitory computer readable medium storing an estimation program for causing a computer to operate as the estimation apparatus according to claim 5.

9. A non-transitory computer readable medium storing an estimation program which when executed causes the method of claim 3 to be performed.
